(19) United States
(12) Patent Application Publication
(10) Pub. No.: US 2004/0194715 A1
(43) Pub. Date: Oct. 7, 2004

(54) Bird feeder guard

(75) Inventors: Mark Zieff, Sudbury, MA (US); John Stone, Southboro, MA (US)

Correspondence Address: PERKINS, SMITH & COHEN LLP, ONE BEACON STREET, 30TH FLOOR, BOSTON, MA, 02108, US

(73) Assignee: Opus, Inc.

(21) Appl. No.: 10/762,992

(22) Filed: Jan. 22, 2004

Related U.S. Application Data
(60) Provisional application No. 60/457,670, filed on Mar. 26, 2003.

(51) Int. Cl. A01K 61/02

(52) U.S. Cl. 119/57.9

(57) ABSTRACT

Disclosed herein is a bird feeder comprising one or more tube chambers, a base, top locking device and a guard. This bird feeder allows a consumer to create multiple designs. For example, the guard of the current invention can be formed by one or more units adjacently disposed upon the feeder. The guard is ostensibly designed to prevent squirrels and other animals from accessing the feed chambers and can be configured in many different ways.

### RELATED APPLICATION

This application claims the benefit of Provisional Application 60/457,670, filed Mar. 26, 2003.

### FIELD OF THE INVENTION

The present invention related to a bird feeder. More specifically, the present invention pertains to a bird feeder guard used as a weather guard and to prevent squirrels and other animals from accessing the contents of a bird feeder.

### BACKGROUND OF THE INVENTION

Bird feeders are structures intended to serve as a fo9od disposal units for a variety of bird species. There are numerous bird feeders currently on the market. Some feeders, in particular nectar feeders, are designed for birds such as humming birds and orioles, while other feeders are designed to dispense seed for seed eating birds.

Typically, a bird feeder consists of one or more feed chambers in which bird feed is contained. Orifices, or portals, are present along the lateral surface of a chamber, thereby permitting access to the feed contained within the chamber. Many bird feeders provide a type of perch element near the orifice thus allowing a bird to rest while accessing the feed within the chamber.

Bird feeders typically reside outdoors. For example, it is not uncommon for a bird feeder to be suspended directly or indirectly from a branch of a tree. Bird feeders can be attached to extension devices extending from the side of a residence or mounted on a pole. Being in the outdoors, bird feeders are subject to not only birds but other animals interested in obtaining food. One such animal is the squirrel. Squirrels are animals that are comfortable in trees and can maneuver quite easily thereon. Without the presence of a guard, squirrels will often partake in accessing feed from a bird feeder. A problem resulting from such squirrel participation is that the birds for whom the feeder was originally intended cannot participate due to the presence of the squirrel. The squirrels scare off the birds as well as tend to eat all of the food leaving little if any for the birds.

Clearly, there is need to have a bird feeder that comprises an animal guard, thus preventing squirrels and other animals from accessing feed and concomitantly scaring off birds from using the feeder and yet retain flexibility in design to allow squirrel partial access should the consumer desire.

### SUMMARY

The present invention pertains to a bird feeder comprising one or more feed chambers, a base, a top locking device and a guard. The bird feeder of the present invention allows for a plurality of designs. The guard of the current invention is formed by one or more units disposed on the feeder. The guard that is designed to prevent squirrels and other animals from accessing the feed chambers can be configured in different ways.

In one embodiment of the present invention, a bird feeder comprises one or more chambers, a base, a top locking device and a guard. In one aspect, the guard is comprised of two or more guard units joined together. The ability to configure the guard to a desired design provides flexibility for the consumer. Conceivably, a consumer may desire to design an incomplete guard, wherein one or more units are disposed adjacent to one another in such a manner as to form an incomplete guard. An incomplete guard is to be understood as a guard whose protective cover does not complete the circumference about the feeder. In another aspect, the guard is complete comprising three individual units that are disposed adjacently and joined together. A complete guard is to be understood as a guard whose protective cover does complete the circumference about the feeder.

In this embodiment, the guard can be positioned atop of the feeder apparatus, alternatively, it can be place beneath the apparatus. When in the above position, i.e., above the feeder apparatus, it prevents squirrels from climbing down, for example, a tree and gaining access from above. When the guard is in the below position, then it prevents squirrels from climbing up, for example, a tree and gaining access to the feed.

The consumer has many options in designing a bird feeder of the present invention. For example, the consumer can opt to use two feeding chambers along with an incomplete guard. In this example, the guard elements can cover only the chambers being employed. Alternatively, a complete guard cover may be desirable. There are many possibilities of design present within this invention.

### BRIEF DESCRIPTION OF THE DRAWINGS

FIG. 1(a) depicts one embodiment of the present invention, (b) depicts one embodiment of a guard;

FIG. 2 depicts a bird feeder of the present invention with some of its attendant elements;

FIG. 3 depicts a bird feeder of the present invention with an incomplete guard; and

FIG. 4 depicts guard units and the top locking device.

### DETAILED DESCRIPTION

The present invention pertains to a bird feeder that can be designed by a consumer. The feeder comprises one or more feed chambers, a base, a top locking device and a guard. One element of the feeder, among others, that can be designed by a consumer is the guard. The guard is ostensibly designed to prevent squirrels and other animals from accessing the feed chambers. However, it may be desirable to allow partial access. The guard of the current invention is formed by one or more guard units adjacently disposed together on the feeder.

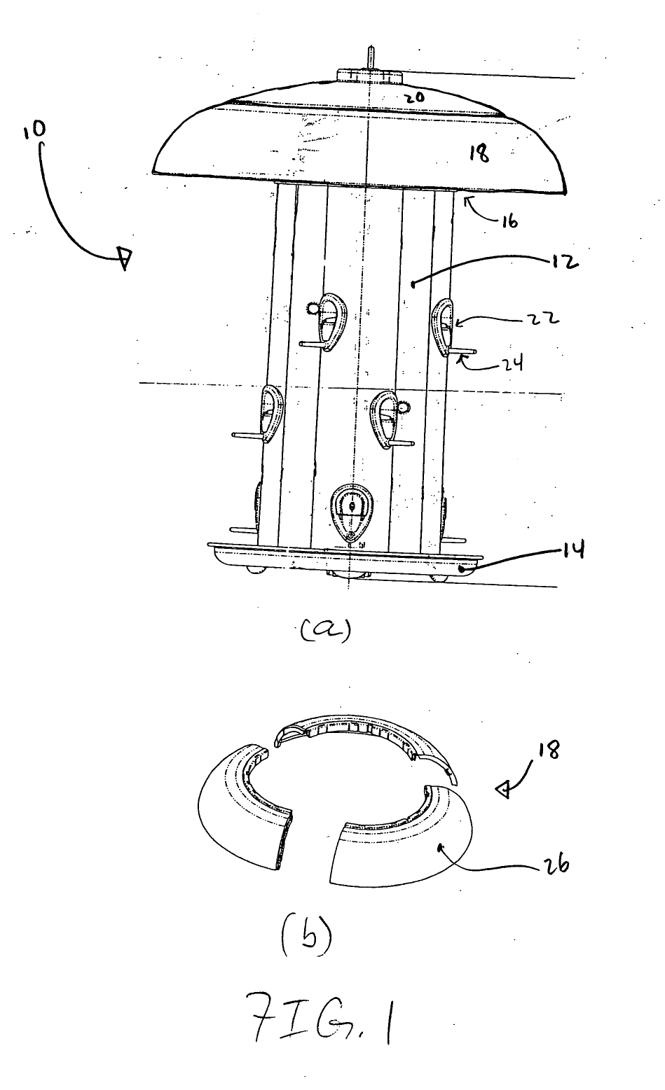

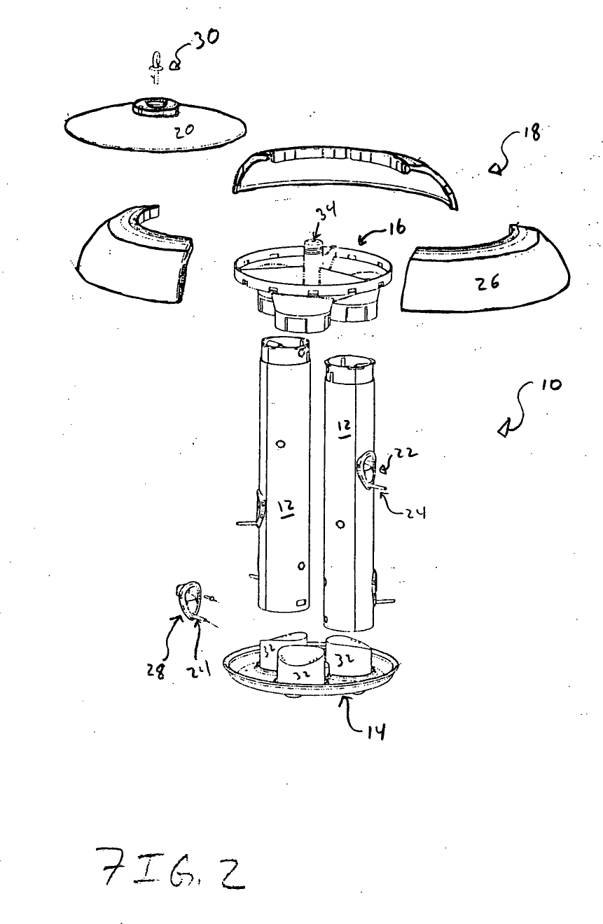

Referring now to the drawings, FIG. 1. depicts one embodiment of the present invention. In FIG. 1(a), a birder feed 10 is depicted having multiple feed chambers 12. In this particular figure, three chambers 12 are depicted. Each feed chamber 12 has one or more orifices (or portals) 22 that allows access to bird feed contained within a given chamber 12. The orifices 22 have one or more perches 24 disposed thereon or nearby, thus allowing, for example, a bird to rest upon while accessing feed within a chamber 12. The feeder of FIG. 1(a) also depicts a base 14 into which the chambers 12 are securely seated. A chamber 12 can be securely disposed within the base 14 using methods well known to those skilled in the art, such as a snap-fit mechanism. A top locking device 16, that is obscured from view by a guard 18 in this particular figure, is used to secure the chambers 12 at the end opposite the base 14. The guard 18 depicted in FIG. 1(a) extends in a horizontal direction beyond the vertical shaft formed by the chambers 12 sufficient enough so as to preclude the possibility of squirrel access. The extension of this guard 18 can vary. In one aspect, the extension of the guard 18 is sufficient to both prevent a squirrel from accessing the feed within a chamber 12 as well as to cover and protect feed (and perhaps the birds as well) from ill-climate weather. One skilled in the art will appreciate that the degree of extension can vary while remaining within the scope of this invention. A dome 20 is depicted in FIG. 1(a). This dome 20 can be part of the guard 18 or independent therefrom as depicted in this figure. The dome 20 is used to cover the top of the feed chambers 12 and in its independent embodiment can be securely affixed to the feeder 10 via the top locking device 16. For example, a screw-like means can be used to secure the dome 20 into a receiving element 34 within the top locking device 16. See FIG. 2.

The guard 18 depicted in FIG. 11(b) depicts an embodiment in which the guard is comprised of multiple units. In a particular example, the guard 18 is comprised of three units 26. Each of these units 26 can be removably and independently secured onto the bird feeder 10 using means well known to those skilled in the art. Additionally, each unit 26 can be removably joined together by means well known to those skilled in the art. For example, two units 26 can be joined to one another via a snap-fit mechanism. Additionally, two or more units 26 can be assembled using a lock and key mechanism. Additional mechanisms include, but are not limited to, press-fit tab and slot, fasteners like screws and bolts, plastic clips and retainer rings that trap the dome sections together. A particular feature to this invention, once the guard units are assembled, they can be disassembled and reconfigured.

Referring now to FIG. 2, some of the elements used to construct a bird feeder of the present invention are shown. It is important to note that all of the elements depicted therein can be removably affixed into proper position. This flexibility of placement of elements within the feeder allows for easy assembly and disassembly. In FIG. 2, only two feed chambers 12 are depicted. These chambers 12 can be securely disposed within the base 14 via chamber receptacles 32 using methods well known to those skilled in the art, such as friction-based securing or snap-fit. Also depicted in this figure are perch apparatuses 28 together with their perches 24. In a particular aspect, the perch element 24 is attached to the perch apparatus 28. The perch apparatus 28 is securely disposed within an orifice 22 using methods well known to those skilled in the art, for example, a snap-fit process.

The other end (i.e., opposite the base 14) of the chambers, referred to as the top end for convenience, can be securely disposed within the top locking device 16 using methods well known to those skilled in the art, such as a snap-fit, lock and key mechanism and alike. A dome 20 can be used to close access to the top of the bird feeder 10, specifically, close access to the top locking device 16. Optionally, a screw 30 can be used to secure the dome 20 into position using a screw receiving element 34 disposed on the top locking device 16. A snap-fit mechanism can also be employed to secure the dome 20 to the locking device 16.

In FIG. 2, one embodiment is depicted wherein there are multiple unassembled guard units 26. In the particular situation depicted by FIG. 2, there are three units 26. It should be obvious to those skilled in the art that there are many different permutations. There can be more than three units or less. Additionally, they need not interact with one another, for example, a gap can exist between the units as they are disposed on the feeder. Obviously, multiple units can be joined while other remain free. The size of the units themselves can vary along with the overall size of the bird feeder. The key is the flexibility in design provided by disassembled guard units. For example, depicted in FIGS. 1 and 2 is a bird feeder 10 that is comprised of a complete guard 18 being comprised of three separate guard units 26 joined together. It is conceivable that for the same feeder 10, less than a complete guard 18 is desired. Perhaps only two guard units 26 are desirable, alternatively, only one guard unit 26 may be desirable. It may be the wish of a consumer to allow squirrels and other animals to have limited access such as access to one or more of the feed chambers 12. This flexibility in design permits the consumer to design his own feeder.

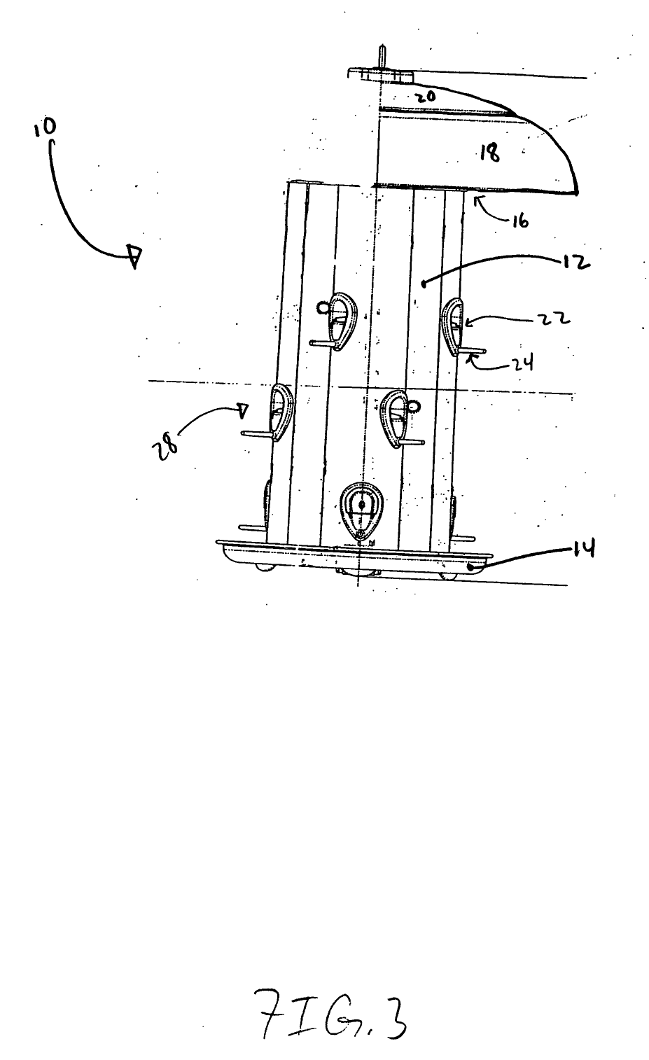

FIG. 3 depicts a bird feeder 10 with an incomplete guard 18. In this figure, three 12 feed chambers are depicted along with their perch assemblies 28. An incomplete guard 18 is also depicted in FIG. 3. In this particular example, one feed chamber is covered while a portion of a second chamber is covered. Obviously, other configurations are envisaged and are considered to be within the scope of this invention. The ability to have a plurality of guard designs is facilitated by employing guard units that can be joined together to form a structure resulting in effectively one guard.

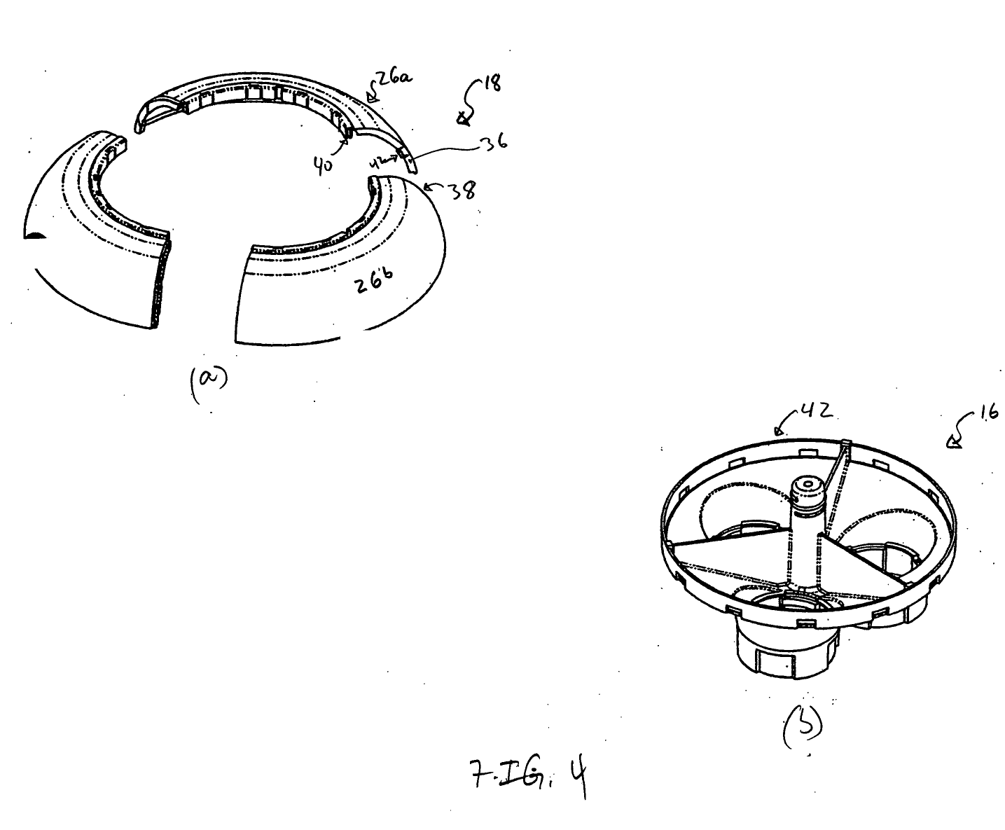

Multiple guard units 26 can be joined by methods well known in the art. Examples of such methods include, but are not limited to, snap-fit, lock and key, hinge, latch, screws, nuts and bolts, threads to screw the dome 26 to the top locking device 16, or a retainer ring to trap the dome 26 between the top locking device 16. Referring to FIG. 4a, two adjoining units 26(a) and (b) can be securely fastened by having a hook-like element 42 on the surface 36 of one unit 26a interlock with a receptacle (not shown) disposed along the surface 38 of an adjoining guard unit 26b.

Individual guard units 26 can be disposed along a surface 42 of the top locking device 16 using methods well known to those skilled in the art. Such methods include uniting a cleft 40 disposed along a guard unit 26 (FIG. 4a) with the apical surface 42 of the top locking device 16 (FIG. 4b). Other means for securing a guard unit 26 onto the top locking device 16 are contemplated to be within the scope of this invention. Such means include, but are not limited to, a snap fit mechanism, a lock and key mechanism, securing using one or more fasteners like a screw, nuts and bolts, retaining rings and alike.

Materials suitable for the construction of a bird feeder along with its attendant elements like the guard include plastic, stainless steel, wood, aluminum, copper, glass, wire, ceramic, and combinations thereof. The material used should be able to withstand the outdoor elements such as rain.

While this invention has been particularly shown and described with references to specific embodiments, it will be understood by those skilled in the art that various changes in form and details may be made therein without departing from the spirit and scope of the invention as defined by the appended claims.

What is claimed is:

1. A squirrel proof bird feeder, comprising:
(a) a base;
(b) one or more feeding chambers, wherein one end of said chambers are securely affixed to said base;
(c) a top locking device, wherein an end of said chambers opposite to said base are securely disposed within said top locking device; and
(d) a guard that is disposed along a surface of said top locking device, wherein said guard has one or more guard units, wherein units in apposition are securely adjoined to one another, and wherein said guard extends over a feeding chamber so as to prevent said squirrel from accessing said feeding chamber.
